(19) United States
(12) Patent Application Publication
(10) Pub. No.: US 2013/0092435 A1
(43) Pub. Date: Apr. 18, 2013

(54) ELECTRODE ASSEMBLY WITH COOLING PASSAGEWAY

(71) Applicants: Christopher L. Spencer, Holly, MI (US); Randall J. Fugaj, Lansing, IL (US); George C. Denton, Lowell, IN (US); Joseph M. Kuechenmeister, Crown Point, IN (US); Grady A. Gipson, Schererville, IN (US)

(72) Inventors: Christopher L. Spencer, Holly, MI (US); Randall J. Fugaj, Lansing, IL (US); George C. Denton, Lowell, IN (US); Joseph M. Kuechenmeister, Crown Point, IN (US); Grady A. Gipson, Schererville, IN (US)

(73) Assignee: FORD GLOBAL TECHNOLOGIES, LLC, DEARBORN, MI (US)

(21) Appl. No.: 13/272,220

(22) Filed: Oct. 13, 2011

(51) Int. Cl. H02G 15/02

(52) U.S. Cl. 174/74 A

(57) ABSTRACT

An electrode assembly with a cooling passageway for improving electrode life expectancy and better weld quality. The electrode assembly includes an electrode body, and an electrode cap detachably coupled to the electrode body. A cooling passageway passes through the electrode assembly for carrying a cooling agent. The cooling agent enters the cooling passageway through an inlet port, removes the welding heat energy from the electrode assembly, and exits the cooling passageway through an outlet port. Further, an elastomeric seal, between a mating surface of the electrode body and the electrode cap, seals the electrode cap to the electrode body.

### TECHNICAL FIELD

This application relates generally to an electrode assembly, and more particularly, to electrodes used in welding.

### BACKGROUND

Motor companies generally employ weld nuts in their assembly lines to provide tight component seals. These nuts are fastened by a welding process that in turn uses an electrode. These electrodes are non-consumable, but they do degrade over time, creating a need for a refurbished electrode. An expected lifespan of an electrode is usually based upon welding environment factors including the length of weld time, the force applied to the electrode, and the amount of welding current. An electrode's chemical, mechanical, and electrical properties also contribute to determining expected electrode life. The available designs of electrodes have a short lifespan relative to the timing of production shifts. In addition, many welding techniques need a large amount of electrode force, as well as welding current, which results in frequent electrode changes. The need to frequently change electrodes increases production costs, as well as introducing human-machine interaction. Such interaction leads to production downtime, as well as a potential for mishaps.

Weld electrodes include locating pins, and changing those pins is another cause of production. The top portion of the pin is subjected to the welding environment, and thus has the potential to degrade over time. Damage to a pin during welding, of course, requires replacement of that element.

Existing electrode designs produce unsatisfactory results, in terms of electrode life expectancy, as well as weld quality. A need therefore exists for an electrode assembly that can work with the existing tools, making a seamless transition into current production, but offers improved life expectancy.

### SUMMARY

One aspect of the disclosure is an electrode assembly for increasing a life expectancy of an electrode. The electrode assembly includes an electrode body, and an electrode cap detachably coupled to the electrode body. The electrode body and the electrode cap are adapted to conduct an electric current. In addition, the electrode assembly includes a cooling passageway passing through the electrode body or the electrode cap. The cooling passageway may carry a cooling agent to remove the heat generated during a welding operation from the electrode body as well as the electrode cap. The cooling agent enters and exits the cooling passageway through an inlet port and an outlet port respectively. The electrode body and the electrode cap may be made of class 3 copper based alloys.

In another aspect of the disclosure, the electrode assembly may also include a cylindrical hole through the electrode cap and the electrode body. A two-piece pin is placed inside the cylindrical hole in the electrode assembly. A top portion pin and a bottom portion pin are placed within the electrode cap and the electrode body, respectively.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 illustrates an embodiment of the present disclosure, in the form of an electrode assembly.

FIG. 2 is a top view of the electrode assembly of FIG. 1.

FIGS. 3A and 3B illustrate a pin design.

FIG. 4 illustrates an alternative embodiment of the present disclosure, in the form of an electrode assembly with a pin.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure describes an electrode assembly with a cooling passageway. The electrode assembly provides an electrode design with an increased electrode life by optimizing the geometry of the electrode. The electrode is designed in two pieces: an electrode body and an electrode capealed together through elastomeric seals exhibiting high thermal stability and chemical resistance. A cooling passageway runs through at least one of the electrode base and the electrode cap to carry a cooling agent. The cooling passageway includes an inlet port and an outlet port. The cooling agent enters and exits the cooling passageway through the inlet port and the outlet port, respectively. As the cooling agent touches the inside surfaces of the electrode on its way through the passageway, the heat produced during welding operation is removed from the electrode. The two piece electrode design allows the one piece with the cooling passageway fittings to remain fixed and stationary when there is a need to change the other piece of the electrode. The cooling passageway fittings, therefore, remain undisturbed when part of the electrode is changed by removing the electrode cap. Further, the electrode design allows predictive maintenance of weld guns during non-productive timings; reducing the complexities of maintenance activities; and reducing the machine downtime.

### Conventional Systems

A conventional electrode assembly includes a single structure electrode. A premature failure of the electrode, therefore, initiates a need to completely remove the electrode and replace a new electrode. In addition, a cooling passageway within the electrode is unable to sufficiently remove the heat produced during the welding operation. The surface area of the cooling passageway in contact with the electrode does not match the heat removal requirements of the electrode. Moreover, conventional systems are made of elkonite copper, a class B copper alloy with tungsten. The mechanical and electrical properties of the elkonite copper do not meet the standards expected for high quality weld and electrode life. As a result, the elkonite copper based electrode is not able to sustain the high amount of welding current, and a large electrode force for a long duration of welding time.

Unfortunately, conventional electrode systems have a short lifespan, mandating frequent changes of an electrode in welding equipment. The replacement process may often lead to wrong placement of the electrode. Conventional systems, therefore, increase the cost of production, as well as introduce frequent human-machine interactions. The human-machine interactions lead to production downtime, and raise the potential for mishaps and mistakes.

### Exemplary Embodiments

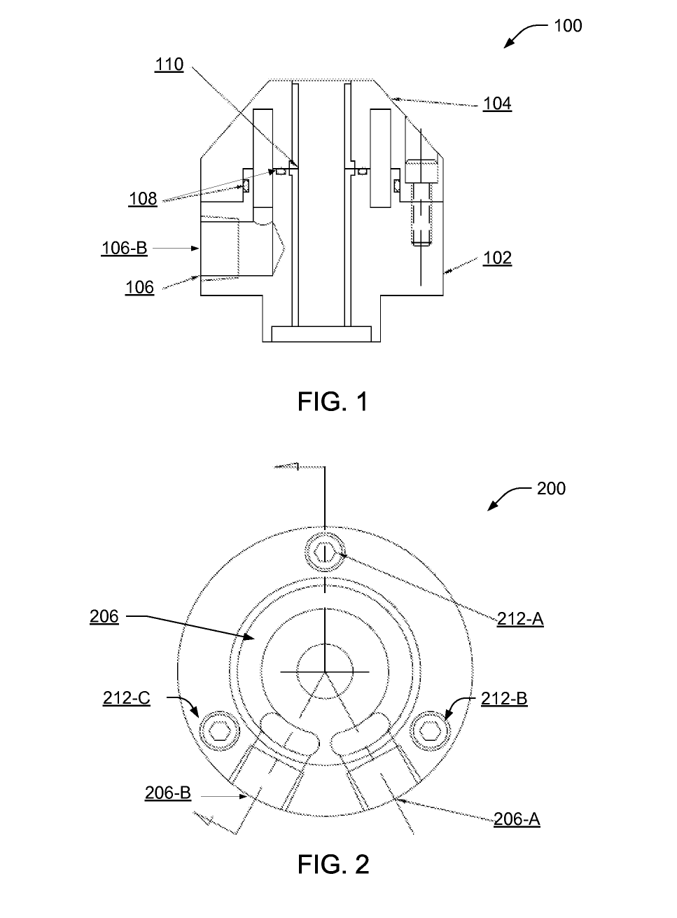

An electrode assembly with a cooling passageway is illustrated in FIG. 1. The major components of the electrode assembly 100 are an electrode body 102, an electrode cap 104, and a cooling passageway 106. The cooling passageway 106 includes an inlet port 106-A, and an outlet port 106-B for a cooling agent to enter and exit the cooling passageway 106. A two piece electrode design with the cooling passageway 106 reduces the production downtime by reducing the time required to change the electrode. Most of the damage during welding occurs at the top portion of the electrode as the top portion is subjected to the toughest welding environment. An old electrode can be refurbished by replacing the old electrode cap 104 with a new electrode cap 104. At the outset, it will be recognized that the present disclosure applies to any welding process that employs an electrode, and particularly welding equipment subject to a large welding current, and a large welding force for a long duration of welding time. Thus, alternative embodiments of the present disclosure could well be used in welding processes such as projection welding, spot welding, resistance welding and the like.

The electrode body 102 forms the base of the electrode assembly 100. The electrode body 102 is adapted to conduct an electric current through a work piece to fuse two pieces together. For example, the electrode body 102 may conduct current through a full-ring projection weld nut to make a water-tight seal between a component and the weld nut. The electrode body 102 may exert pressure on work-pieces to be welded to hold the work-pieces together. Further, the electrode body 102 may concentrate a welding current into a region of the work-piece to force a large current through the region, forming a weld. Using the electrode body 102, a lot of energy can be delivered to the work-piece region in a very short time. The time may be as short as approximately ten milliseconds, permitting the welding to occur without excessive heating to the rest of the work-piece.

The electrode body 102 includes a cooling passageway 106 within the body to remove the heat produced during the welding operation. The surface area of the electrode body 102 in contact with the cooling passageway 106 determines the heat carrying capacity of the cooling passageway 106. The electrical properties of the electrode body 102 control the amount of heat energy delivered to the work-piece region. In this embodiment, the electrode body 102 has a circular cross-section. In other embodiments (not shown), other cross sections can be used. Further, in this embodiment, the electrode body 102 is made of class 3 copper based alloys. The electrical, mechanical and chemical properties of the class 3 copper based alloy enables the electrode to sustain the high amount of welding current, and a large electrode force for a long duration of welding time. As a result, the electrode life is increased, and the electrode assembly 100 is able to deliver a better weld quality. As a welding application requires a combination of high electrical conductivity, temperature strength, mechanical strength, and high wear and corrosion resistance, class 3 copper based alloys for the electrode body 102 improves the electrode life.

The electrode cap 104 forms the top portion of the electrode assembly 100, which is the part of the electrode subjected to the toughest welding environment. The electrode cap 104 is detachably coupled to the electrode body 102 as depicted in the FIG. 1. An elastomeric seal 108, such as the Viton seal, may be used to seal the electrode cap 104 to the electrode body 102. The elastomeric seals 108 are placed between a mating surface of the electrode cap 104 and the electrode body 102. Whenever a need arises for replacement of a new electrode, the electrode cap 104 can be easily detached from the electrode body 102. The electrode cap 104 directs the pressure exerted by the electrode body 102 to the work-pieces to hold the work-pieces together. In addition, the electrode cap 104, adapted to conduct an electric current, forces a large current into a region of the work-piece to melt the region and form the weld. The electrode cap 104 delivers a lot of energy to the work-piece region in a very short time without excessively heating the rest of the work-piece.

The cooling passageway 106 passes through the electrode cap 104 to remove the heat produced during the welding operation. The surface area of the electrode cap 104 in contact with the cooling passageway 106 determines the heat carrying capacity of the cooling passageway 106. The electrical properties, of the electrode cap 104, control the amount of heat energy delivered to the work-piece region. The electrode cap 104 has a circular cross-section. In other embodiments (not shown), other cross sections can be used. Further, the electrode cap 104 is made of class 3 copper based alloys. In another embodiment, the cooling passageway 106 may pass through only the electrode body 102. Such an arrangement may reduce the complexities associated with electrode replacement and maintenance activities.

According to an embodiment of the disclosure, the electrode body 102 and the electrode cap 104 have a through hole located along the central axis of the electrode assembly 100. In this embodiment, the through hole is cylindrical in shape. In other embodiments, other shapes can be used.

The cooling passageway 106 passes through the electrode assembly 100 to remove the heat produced during the welding operation. The cooling passageway 106 is in the form of an annular groove extending circumferentially of the electrode assembly 100. The inlet port 106-A and the outlet port 106-B located on the surface of the electrode body 102 allow a cooling agent to enter and exit the cooling passageway 106. The cooling agent may be a liquid, a fluid or a gas. For example, water can enter the cooling passageway 106 through the inlet port 106-A, and exit through the outlet port 106-B. The cooling agent, while passing through the cooling passageway 106, extracts the heat from the electrode body 102, as well as the electrode cap 104. The cross-section of the cooling passageway 106 may have a rectangular shape, a circular shape, or the like. As the speed of the flow of cooling agent is dependent on the cross-sectional area, the dimensions of the cooling passageway 106 are designed depending on the speed flow requirements for a welding application. In addition, based on the welding application and the heat removal requirements, a specific cross sectional shape is chosen. In one embodiment, a rectangular cross-sectional cooling passageway 106 passes through the electrode assembly 100. Further, the inlet port 106-A and the outlet port 106-B have a circular cross-section. The diameter of the circular cross-section may range from ⅛ inch to 5/16 inch. For example, the inlet port 106-A, and the outlet port 106-B may be drilled and tapped for ¼ inch-18 NPT. The ports are made as large as possible to allow for greater cooling capacity. The cooling passageway 106 may be designed around a surface area of approximately ⅜ inch hole. A relationship between the sizes of the electrode assembly 100 to the inlet and outlet ports may be based upon the flow of cooling agent (for example, for water gallon per minute), available plumbing fittings at a plant, and the like. The diameter of the ports may vary based upon the application, the requirements and parameters such as fixture duty cycle, the amount of heat generated (or lack of heat), cooling agent temperatures, and the like.

The elastomeric seals 108 isolate the cooling agent to the required design ports inside the electrode assembly 100. The elastomeric seals 108 are selected based on their physical properties, chemical properties, thermal properties, electrical properties, and mechanical properties. The performance of the elastomeric seals 108, in the high temperature and high pressure environmental conditions, during the welding process, determines the stability of the electrode assembly 100 design. The elastomeric seals 108 are designed to not inhibit the interference fit between the electrode body 102 and the electrode cap 104, and the welding current conduction path. When subjected to continuous service for a long time under high temperatures, the elastomeric seals 108 retain their mechanical properties. Excellent resistance to atmospheric oxidation, sun, weather, fungus and mold are features of the elastomeric seals 108. The elastomeric seals 108 exhibit good resistance to compression set, and extrusion, and retention of elastic properties over time. Such sealing properties reduce lifetime costs of the electrode assembly 100 by preventing seal failures, extending maintenance intervals, increasing safety, and meeting stringent environmental regulations.

The two-piece electrode design, including the electrode body 102 and the electrode cap 104, advantageously allow replacement of a new electrode with reduced complexity, as well as reduced production downtime. During welding operation, the electrode cap 104 is subjected to the toughest welding environment and suffers most of the damage as compared to the electrode body 102. Whenever an electrode fails, or is otherwise in need of replacement, the electrode cap 104 can be easily replaced without disturbing the arrangement of the electrode assembly 100. The cooling passageway 106 fittings, therefore, remain unchanged and stationary. Further, human-machine interaction is significantly reduced by only replacing the electrode cap 104. A reduced interaction during replacement reduces the accidental occurrence of incorrect installation of the electrode assembly 100.

In an alternative embodiment, the electrode assembly 100 may also include an insulator 110 to insulate the electrode body 102 and the electrode cap 104. The insulator 110 prevents the shorting of welding current through the electrode and the welding work-pieces. The insulator 110 may also be designed in two pieces. A first piece insulator insulates the electrode cap 104 and a second piece insulator insulates the electrode body 102. The insulator 110 is made of a material that has superior electrical and thermal insulating properties; and is stable when exposed to high electric current and high temperatures. An electrically-nonconductive resin impregnated fiber compound may be selected for making the insulator 110. For example, the insulator 110 may be made of micarta.

FIG. 2 illustrates a top view of the electrode assembly 100 of the FIG. 1. The top view shows a cooling passageway 206 in the shape of an annular ring, including an inlet port 206-A, and an outlet port 206-B. Fasteners, such as the hex head cap screws 212-A, 212-B, 212-C, are used to attach the electrode cap 104 and the electrode body 102.

The electrode cap 104 is held to the electrode body 102 by the three hex-head cap screws 212. The cap screws 212 have a defined pattern which makes positive location possible, ensuring the correct placement of the electrode cap 104 to the electrode body 102. The type and size of cap screw 212 may be selected based on the forces required to adequately secure the mechanical connection between the electrode cap 104 and the electrode body 102. Whenever a need arises for replacement of a new electrode, the electrode cap 104 can be easily detached from the electrode body 102. The cap screws 212 are loosened and removed to detach the electrode cap 104 from the electrode body 102. The elastomeric seals 108 may be reused in a new electrode assembly 100.

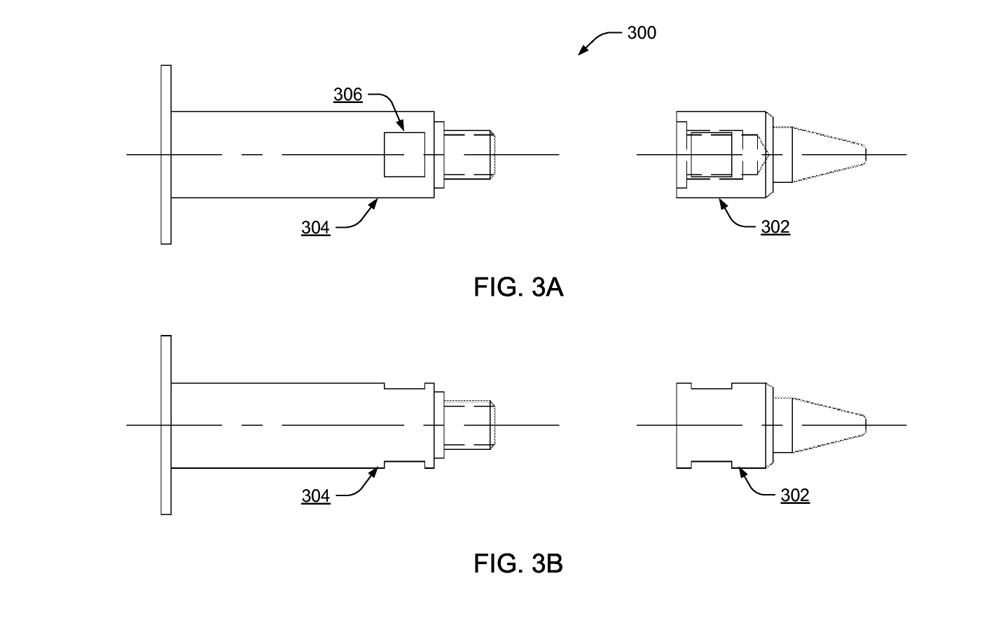

In an alternative embodiment, the electrode assembly 100 shown in FIG. 1 may also include a two-piece pin 300, as illustrated in FIG. 3A and FIG. 3B. FIG. 3A and FIG. 3B are a top view and a front view, respectively, of the two-piece pin 300. The two-piece pin 300 includes a top portion pin 302 and a bottom portion pin 304. The pin 300 may be used to correctly locate work-pieces such as full-ring projection weld nuts. The pin 300 also includes flats 306 for use by wrenches to break the threads of the pin 300.

The two-piece pin design advantageously allows replacement of a new pin with reduced complexity, as well as reduced production downtime. The top portion pin 302 is subjected to the toughest welding environment, and suffers most of the damage, as compared to the bottom portion pin 304, during a welding operation. In conventional systems, the complete electrode is removed, including the electrode body, to change a pin. In the present design, whenever a need arises to change the pin 300, the top portion pin 302 can be easily replaced by pulling out only the electrode cap 104, without disturbing the arrangement of the electrode assembly 100. The electrode assembly 100, including the cooling passageway 106 fittings, therefore, remains unchanged and stationary. Further, human-machine interaction is significantly reduced by only having to remove the electrode cap 104 during a pin change. A reduced interaction reduces the chances of incorrect installation of the electrode assembly 100.

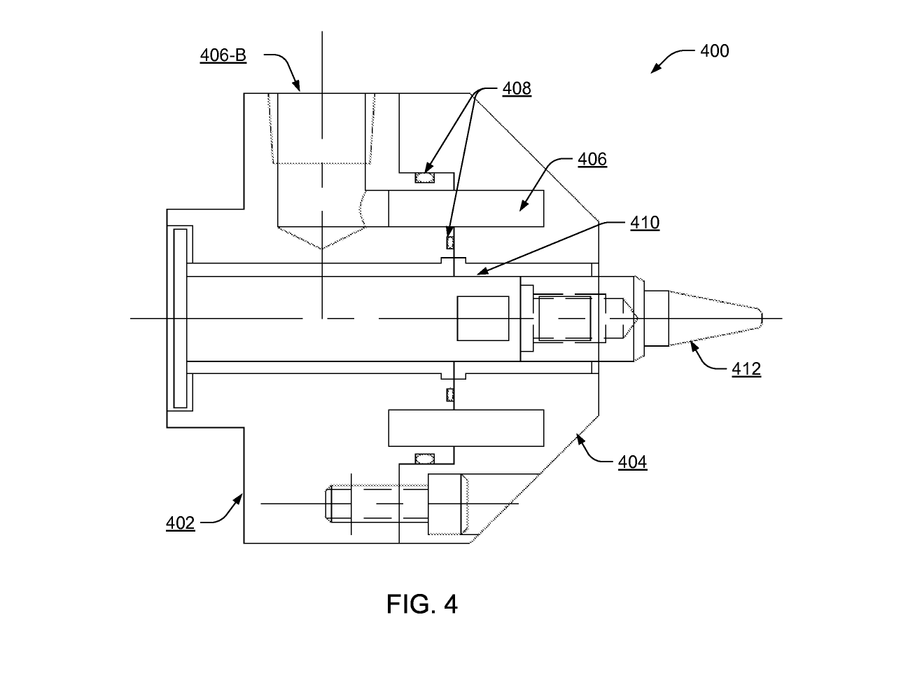

FIG. 4 illustrates an electrode assembly 400 with a two-piece pin 412. The two-piece pin 412 is placed within a cylindrical hollow region of the electrode assembly 400. The electrode assembly 400 is similar in design to the electrode assembly 100 described in FIG. 1. The electrode assembly 400 includes an electrode body 402, an electrode cap 404, and a cooling passageway 406. The cooling passageway 406 includes an inlet port 406-A, and an outlet port 406-B for a cooling agent to enter and exit the cooling passageway 406. An elastomeric seal 408 seals the electrode cap 104 to the electrode body 402. The elastomeric seals 408 are placed between a mating surface of the electrode cap 404 and the electrode body 402. Further, an insulator 410 insulates the electrode body 402 and the electrode cap 404 from the two-piece pin 412.

The two-piece pin 412 may stick within the electrode assembly 400 due to thermal expansion caused by lack of adequate cooling. The cooling passageway 406, by properly cooling the electrode assembly 400, prevents the two-piece pin 412 from sticking within the electrode assembly 400.

In an alternative embodiment, a fiber optic is placed at the top portion of the two-piece pin 412 to measure a movement distance of the electrode assembly 400 relative to a work surface. When a work-piece, such as a full-ring projection weld nut, is fed to the electrode assembly 400, the weld nut lands on the top of the two-piece pin 412. The electrode assembly 400 may move and push the weld nut to a second work-piece. The two-piece pin 412 moves with the electrode assembly 400, as well. As a result, the fiber optic measures the distance moved by the electrode assembly 400, as well as ensures that the weld nut is orientated correctly to the second work-piece.

During a welding operation, a large electric current induces a large magnetic field, and the electric current and magnetic field interact with each other to produce a large magnetic force. The alloy material of the electrode assembly 100, therefore, is chosen based on the magnetic properties of the alloy.

The design of the electrode assembly increased the electrode life expectancy by a factor of ten. Lessened welding machine downtime, reduced maintenance related human-machine interactions, and reduced complexities in maintenance activities are improvements noted due to the electrode assembly design. The electrode assembly described in the disclosure may be used to weld work-pieces such as weld studs, nuts, other screw machine parts, a sheet, and the like.

The specification sets out a number of specific exemplary embodiments, but those skilled in the art will understand that variations in these embodiments will naturally occur in the course of implementing the subject matter of the disclosure in specific environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

We claim:

1. An electrode assembly, comprising:
an electrode body;
an electrode cap detachably coupled to the electrode body;
wherein the electrode body and the electrode cap are adapted to conduct an electric current; and
a cooling passageway passing through at least one of the electrode body and the electrode cap for carrying a cooling agent, the cooling passageway including:
an inlet port, and
an outlet port.

2. The electrode assembly of claim 1, further comprising an elastomeric seal between a mating surface of the electrode body and the electrode cap to seal the electrode cap to the electrode body.

3. The electrode assembly of claim 1, wherein the electrode body and the electrode cap are made of class 3 copper based alloys.

4. The electrode assembly of claim 1, wherein the inlet port and the outlet port have a circular cross-section.

5. The electrode assembly of claim 4, wherein the circular cross-section has a diameter ranging from ⅛ inch to 5/16 inch.

6. The electrode assembly of claim 1, further comprising a cylindrical hole through the electrode cap and the electrode body.

7. The electrode assembly of claim 6, further comprising a two-piece pin including a top portion and a bottom portion, the two-piece pin being located inside the cylindrical hole.

8. The electrode assembly of claim 7, further comprising an insulator between the two-piece pin, and the electrode body and the electrode cap.

9. The electrode assembly of claim 7, further comprising a fiber optic placed at the top portion of the two-piece pin to measure a movement distance of the electrode assembly relative to a work surface.

10. The electrode assembly of claim 1, further comprising fasteners to attach the electrode cap and the electrode body.

11. The electrode assembly of claim 10, wherein the fasteners are hex head cap screws.
